(19) United States
(12) Patent Application Publication
(10) Pub. No.: US 2025/0035886 A1
(43) Pub. Date: Jan. 30, 2025

(54) OSCILLATING MIRRORS FOR LIDAR

(71) Applicant: Cepton Technologies, Inc., San Jose, CA (US)

(72) Inventors: Roger Cullumber, Hollister, CA (US); Chang Shin, Oakland, CA (US); Si Tan, Santa Clara, CA (US); Jun Pei, Saratoga, CA (US); Liqun Han, Pleasanton, CA (US); Dongyi Liao, Mountain View, CA (US); Mark A. McCord, Los Gatos, CA (US); Chao Gu, Ottawa (CA)

(73) Assignee: Cepton Technologies, Inc., San Jose, CA (US)

(21) Appl. No.: 18/787,427

(22) Filed: Jul. 29, 2024

Related U.S. Application Data
(60) Provisional application No. 63/529,278, filed on Jul. 27, 2023.
(60) Provisional application No. 63/529,273, filed on Jul. 27, 2023.

(51) Int. Cl. G02B 7/182; G01S 7/481

(52) U.S. Cl. CPC G02B 7/1821; G01S 7/4815

(57) ABSTRACT

An oscillating mirror for lidar has a mirror coupled with a rotor. The rotor is arranged to rotate about a pivot using one or more bearings. A mirror is coupled with the rotor and arranged to reflect light emitted from a laser. A first magnet is coupled with the rotor. A second magnet is coupled with a base. The second magnet is arranged to limit an angular rotation of the rotor by a pole of the second magnet facing a similar pole of the first magnet.

### CROSS-REFERENCES TO RELATED APPLICATIONS

This application claims the benefit of U.S. Provisional Patent Application Nos. 63/529,278 and 63/529,273, both filed on Jul. 27, 2023, the disclosures of which are incorporated by reference in their entirety for all purposes.

### BACKGROUND

Three-dimensional sensors can be applied in autonomous vehicles, drones, robotics, security applications, and the like. For example, lidar projects an optical beam and detects light of the optical beam reflected by one or more objects in an environment. Lidar can be used to create a three-dimensional map of the environment, or portion thereof, based on detecting reflected light of the optical beam. Scanning lidar sensors may achieve high angular resolutions appropriate for such applications at an affordable cost. An example of a scanning lidar system is provided in U.S. Pat. No. 10,690,754, granted on Jun. 23, 2020, which is incorporated by reference for all purposes. However, improved scanning systems, apparatuses, and/or methods are desired.

### SUMMARY

This disclosure, without limitation, relates to an oscillating mirror for lidar. In certain configurations, a system for lidar comprises a rotor arranged to rotate about a pivot using one or more bearings, the rotor comprising a body encircling the pivot, a mirror support extending from the body, and/or a leg extending from the body; a mirror coupled with the rotor at the mirror support and arranged to reflect light emitted from a laser; a motor arranged to apply a force to the rotor; a first magnet coupled with the leg of the rotor; a base; and/or a second magnet coupled with the base and arranged to limit an angular rotation of the rotor by a pole of the second magnet facing a similar pole of the first magnet. In some configurations, the leg extends in a direction from the body of the rotor that is perpendicular to the mirror.

In some configurations, a system for lidar comprises a rotor arranged to rotate about a pivot using one or more bearings; a mirror coupled with the rotor and arranged to reflect light emitted from a laser; a motor arranged to apply a force to the rotor; a first magnet coupled with the rotor; a base; and/or a second magnet coupled with the base and arranged to limit an angular rotation of the rotor by a pole of the second magnet facing a similar pole of the first magnet. In some configurations, the system comprises the laser; the laser is a first laser; the system comprises a second laser; the mirror is a first mirror; the system comprises a second mirror coupled with the rotor; the first laser is arranged to illuminate the first mirror; the second laser is arranged to illuminate the second mirror; the rotor comprises a body encircling the pivot; the rotor further comprises a leg extending from the body; the first magnet is coupled with the leg of the rotor; the base comprises a first bumper; the second magnet is coupled with the first bumper; the base further comprises a second bumper; a third magnet is coupled with the second bumper, the third magnet arranged to limit angular rotation of the rotor in a direction opposite that the first bumper limits rotation; the first magnet is part of a first plurality of magnets coupled with the rotor; the second magnet is part of a second plurality of magnets coupled with the base; the first plurality of magnets are arranged on the rotor to have alternating polarities; the second plurality of magnets are arranged on the base to have alternating polarities; the first plurality of magnets are arranged to limit the angular rotation of the rotor by poles of the second plurality of magnets facing similar poles of the first plurality of magnets; the mirror has a width equal to or greater than 1 cm; the first magnet and the second magnet are rare-earth magnets; the first magnet is mounted parallel to the mirror; and/or the system further comprises an angle encoder arranged to measure an angle of rotation of the rotor, a routing mirror, and/or a memory device comprising instructions that, when executed by one or more processors, adjust the routing mirror to correct for errors in scan positions.

In some configurations, a method for using an oscillating mirror comprises rotating a rotor about a pivot using one or more bearings, wherein a mirror is coupled with the rotor; emitting light from a laser toward the mirror; reflecting light from the laser using the mirror while the mirror is rotated with the rotor; and/or limiting rotation of the rotor using a first magnet and a second magnet, the first magnet coupled with the rotor and the second magnet coupled with a base, the second magnet arranged to limit an angular rotation of the rotor by a pole of the second magnet facing a similar pole of the first magnet. In some configurations, the laser is a first laser; the mirror is a first mirror; the method further comprises emitting light from a second laser toward a second mirror concurrently with emitting light from the first laser toward the first mirror, and reflecting light from the second laser using the second mirror while the second mirror is rotated with the rotor; the second mirror is coupled with the rotor; the rotor comprises a body encircling the pivot; the rotor comprises a leg extending from the body; the first magnet is coupled with the leg of the rotor; the method further comprises limiting rotation of the rotor by limiting travel of the leg of the rotor; the base comprises a first bumper; the second magnet is coupled with the first bumper; the base further comprises a second bumper; the method further comprises limiting an angular rotation of the rotor in a direction opposite that the first bumper limits rotation using a third magnet coupled with the second bumper; the first magnet is part of a first plurality of magnets coupled with the rotor; the second magnet is part of a second plurality of magnets coupled with the base; the first plurality of magnets are arranged on the rotor to have alternating polarities; the second plurality of magnets are arranged on the base to have alternating polarities; the first plurality of magnets are arranged to limit the angular rotation of the rotor by poles of the second plurality of magnets facing similar poles of the first plurality of magnets; the method further comprises measuring an angle of rotation of the rotor using an angle encoder; and/or the mirror has a width equal to or greater than 1 cm.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIGS. 1A, 1B, and 1C illustrate an embodiment of an oscillating lidar mirror mount.

FIG. 2 depicts an embodiment of a multi-sided oscillating mirror for lidar.

FIG. 3 depicts an embodiment of multisource lidar system.

FIG. 4 illustrates a perspective view of an embodiment of an oscillating lidar mirror.

FIG. 5 depicts a top view of the oscillating lidar mirror in FIG. 4.

FIG. 6 depicts an embodiment of using multiple magnets to limit rotation of a rotor.

FIG. 7 depicts an embodiment of using a metal shield around a magnet.

FIG. 8A depicts an embodiment of a slot arrangement for magnets.

FIG. 8B depicts an embodiment of an oscillating mirror using bumpers from FIG. 8A.

FIG. 9 illustrates a flowchart of an embodiment of a process for using an oscillating mirror in a lidar system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

This disclosure relates generally to laser-based sensors and, without limitation, to an oscillating mirror for lidar. Many laser-based sensors, such as lidar, use mechanical scanning in at least one, if not two, dimensions. Such systems often make use of a scanning mirror, which can be a rotating polygon or an oscillating mirror. A rotating polygon can have undesirable “dead times” where mirror facets do not point in a desired direction, and the system waits until the polygon rotates to a more favorable angle. If a vertical scanning mirror is combined with a rotating polygon for 2D scanning, a non-linearity in the scan lines can be introduced. Using an oscillating mirror (e.g., a galvanometer mirror or a galvo mirror), instead of a rotating polygon, can overcome some of these issues, but it can be difficult to achieve a large field of view using an oscillating mirror due to mechanical design constraints or excess power consumption. Many galvo mirrors are limited to a 30 to 60 degree scan range, whereas some applications for lidar call for a 90 to 120 degree field of view (FOV).

Galvo mirrors can be operated in a resonant mode or non-resonant mode. In resonant mode, the frequency is fixed, determined by a stiffness of a spring and a weight of the mirror. This can be undesirable when the LiDAR uses a specific frequency (e.g., 30 Hz frame rate) or different frequencies (e.g., ability to run at 24 Hz or 30 Hz frame rates). In some cases, it may be advantageous to change the mirror frequency to allow for higher resolution in certain areas of the field of view of the lidar. Additionally, in resonant mode the angular motion of the mirror follows a sine wave, which results in a faster scan motion in the middle of the field of view and a slower scan motion at the edges of the field of view. In some configurations, it is preferred to have a near constant scan motion across the FOV.

In non-resonant galvo mirrors, the mirror angular motion can be more linear. However, the non-resonant galvos are much less efficient and typically use large motors to drive the mirror, where size can cause packaging issues. In addition, the large motors consume considerable power, which can cause thermal issues. Finally, non-resonant galvo mirrors can be limited to a few 10's of Hz scan rate at best, which may be insufficient for some imaging applications.

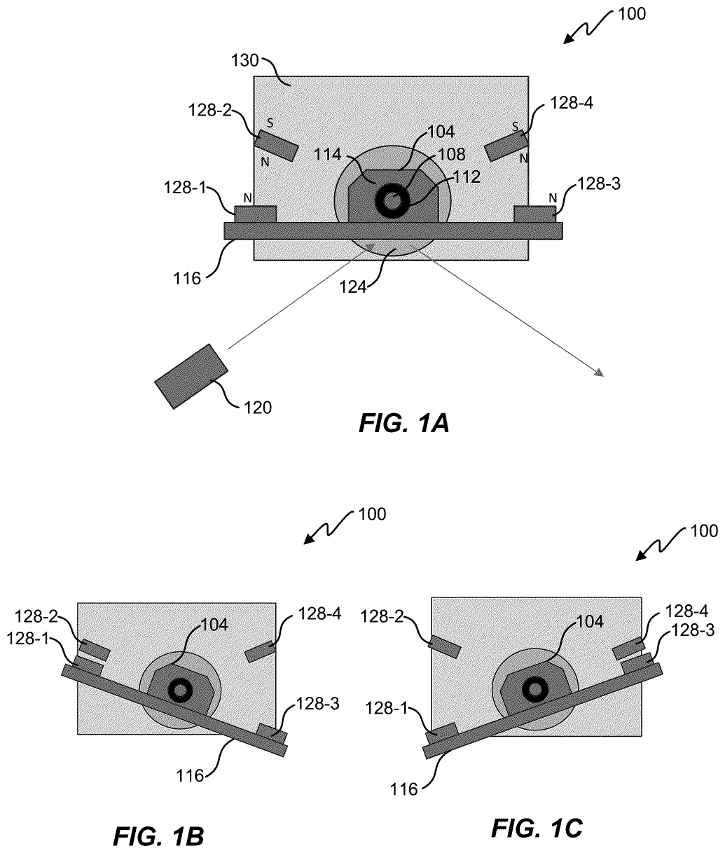

FIGS. 1A, 1B, and 1C illustrate an embodiment of a system 100 for an oscillating lidar mirror. Opposing permanent magnets are used to provide force to reverse motion of the rotor at the end of each scan. The system 100 comprises a rotor 104 arranged to rotate about a pivot 108 using one or more bearings (e.g. pivot bearing 112). The rotor 104 comprises a rotor body 114 that encircles the pivot 108. A mirror 116 is coupled with the rotor 104 and arranged to reflect light emitted from a laser 120. A motor 124 is arranged to apply a force to the rotor 104. A first magnet 128-1 is coupled with the rotor 104. A second magnet 128-2 is coupled with a base 130. The base 130 is arranged to remain stationary while the rotor 104 rotates about the pivot 108 (e.g., the pivot 108 is fixedly coupled with the base 130). The second magnet 128-2 is arranged to limit an angular rotation of the rotor 104 by a pole of the second magnet 128-2 facing a similar pole of the first magnet 128-1. As the first magnet 128-1 is rotated within proximity of the second magnet 128-2, the second magnet 128-2 repels the first magnet 128-1 (e.g., because north poles of the first magnet 128-1 and the second magnet 128-2 repel each other). The first magnet 128-1 can be referred to as a moving magnet or a rotor magnet. The second magnet 128-2 can be referred to as a bumper magnet or a stationary magnet. A third magnet 128-3 and a fourth magnet 128-4 are also shown in FIG. 1. The third magnet 128-3 is a second moving magnet and the fourth magnet 128-4 is a second bumper magnet. The magnets 128 are permanent magnets.

The rotor 104 rotates the mirror 116 until rotation is stopped by bumper magnets (e.g., magnets 128-2 and 128-4). By placing opposing permanent magnets near the end of the travel of the oscillating mirror in each direction, the mirror 116 can be forced to quickly reverse its direction of travel by the action of the magnetic fields. The energy from the rotor motion is stored in the magnetic field and released back to the rotor as the mirror 116 starts to move in the opposite direction. This results in a very energy efficient operation, reducing the size and power usage of the motor 124. The mirror 116 is fixedly attached to the rotor 104 to block relative motion between the mirror 116 and the rotor 104. The magnetic bumpers provide a non-contact method to reverse the direction of the mirror pivot. Unlike spring or rubber bumpers, there is little to no wear and tear, reduced or minimal vibration, and/or reduced or minimal energy loss associated with the non-contact magnetic bumpers.

In some embodiments, the mirror 116 has a width (e.g., measured in a direction orthogonal to an axis of rotation of the rotor 104) equal to or greater than 1, 2, 3, or 4 cm and/or equal to or less than 10, 7, 6, or 5 cm. For example, the mirror 116 has a width of 1.5, 2.0, 2.5, or 3.0 inches. In some embodiments, the width of the mirror 116 is equal to or greater than 1, 2, 3, or 4 cm because a smaller width can limit a scanning field of view of the lidar system below a desired threshold.

In FIG. 1A, the first magnet 128-1 and the third magnet 128-3 are mounted parallel to the mirror 116 (e.g., so that the magnetic flux of the first magnet 128-1 and the third magnet 128-3, at a center of the respective magnet, is parallel to a normal of the mirror 116) and at opposite ends of the mirror 116 (e.g., the first magnet 128-1 is positioned at a left end of the mirror 116 and the third magnet 128-3 is positioned at a right end of the mirror 116). The first magnet 128-1 and the third magnet 128-3 are positioned on an opposite, or reverse, side of the mirror 116 (e.g., the first magnet 128-1 and the third magnet 128-3 are on a side of the mirror 116 that is opposite of a reflective surface 116 of the mirror).

FIG. 1B shows an embodiment of the rotor 104 being stopped in a clockwise rotation direction by the second magnet 128-2. The mirror 116 is in the extreme clockwise position, where the force between the first magnet 128-1 and the second magnet 128-2 causes the mirror 116 to stop and reverse direction. FIG. 1C shows an embodiment of the rotor 104 being stopped in a counterclockwise rotation direction by the fourth magnet 128-4. The mirror 116 is in the extreme counterclockwise position where the force between the third magnet 128-3 and the fourth magnet 128-4 causes the mirror 116 to stop and reverse direction.

The rotor 104 pivots using a mechanical bearing, which can be a ball bearing, roller bearing, rod bearing, sleeve bearing, rotational bearing, or other type of bearing. This can allow a greater range of scan motion than typical flexure mechanisms, although a flexure bearing can also be used in some embodiments. At the end of each travel, the moving magnet(s) come up against the stationary bumper magnet(s), where the fields are arranged so that the north pole (or south pole) of the moving magnet presses against the same pole of the bumper magnet.

The motor 124 uses a magnetic drive with permanent magnets. The magnetic drive is arranged to rotate freely, except for a low amount of friction in the bearing(s), when not acted upon by a magnetic force, unlike a torsion spring that provides mechanical force as the torsion bar rotates. Additionally, the rotor could rotate in a full circle if not limited by bumpers (e.g., bumper magnets) or other stops. An advantage of using a rotor that is free to rotate, instead of using a torsion spring, is that motion of the mirror 116 has a more consistent (or constant) angular velocity in a field of view of the lidar. A torsion spring gives non-linear motion. Accordingly, the system does not use a torsion spring (or torsion bar), in some embodiments, and instead uses bearings to allow the rotor 104 to rotate freely around the pivot 108.

In a middle portion of the scan motion, the field from the permanent magnets is much reduced, allowing the mirror 116 to pivot freely with relative constant angular velocity. This non-sinusoidal motion is generally preferable to a sinusoidal motion that has constantly changing angular velocity. The motor(s) provide a relatively small force to counter the friction of the air and/or the bearing(s). The oscillation frequency can be varied over a relatively wide range by changing the power to the motor. As the power is increased, the mirror 116 will move faster, resulting in a faster frequency of oscillation. In some embodiments, this is true so long as the bumper magnet has sufficient force to reverse the travel direction of the mirror 116 without the moving magnet physically contacting the bumper magnet. In some embodiments strong magnets (e.g., rare-earth magnets) are used. In some embodiments, a magnet with a magnetic flux density equal to or greater than 0.75 and/or equal to or less than 1.5 is used for a bumper magnet.

In some configurations, a system comprises a first bumper magnet (e.g., second magnet 128-2) and second bumper magnet (e.g., fourth magnet 128-4), wherein the second bumper magnet is arranged to limit an angular rotation of the rotor in a direction opposite the first bumper magnet (e.g., the first bumper magnet limits clockwise rotation, and the second bumper magnet limits counterclockwise rotation).

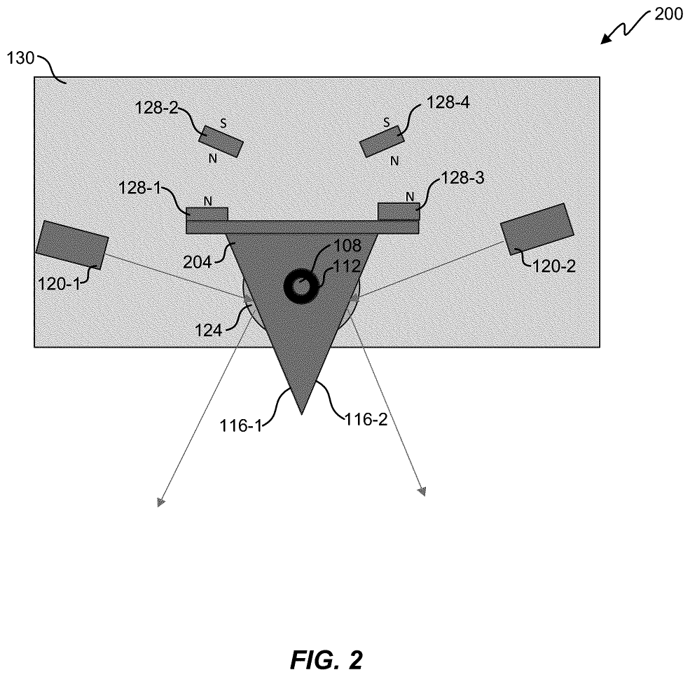

FIG. 2 depicts an embodiment of a lidar system 200 using a multi-sided oscillating mirror. The lidar system 200 in FIG. 2 comprises a rotor 204, pivot 108, pivot bearing 112, a first mirror 116-1 and a second mirror 116-2, a first laser 120-1 and a second laser 120-2, a motor 124, magnets 128, and a base 130. The first mirror 116-1 is coupled to a first mirror support (e.g., a flat or curved surface) of the rotor 204. The second mirror 116-2 is coupled to a second mirror support.

The first laser 120-1 is arranged to illuminate the first mirror 116-1. The second laser 120-2 is arranged to illuminate the second mirror 116-2. The rotor 204 oscillates the mirrors 116. The second mirror 116-2 is not parallel or perpendicular to the first mirror 116-1. The second mirror 116-2 is set at an angle with respect to the first mirror 116-1, wherein the angle is equal to or greater than 15, 20, 25, 30, or 45 degrees and/or equal to or less than 120, 90, 60, 45, or 30 degrees.

Two lasers 120 and two mirrors 116 can be used to increase a field of view of the lidar system 200.

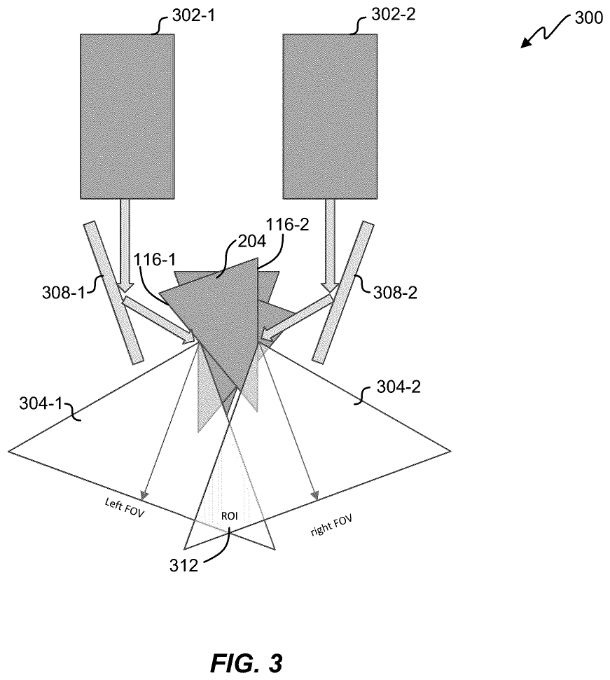

FIG. 3 depicts an embodiment of multisource lidar system 300. The multisource lidar system 300 comprises the elements shown in FIG. 2, including rotor 204, the first mirror 116-1, and the second mirror 116-2. The first laser 120-1 in FIG. 2 is part of a first optical module 302-1. The second laser 120-2 in FIG. 2 is part of a second optical module 302-2. The optical module 302 comprises a laser and a detector. In some embodiments, the laser is part of a laser array and/or the detector is part of a detector array. The following commonly owned patent applications are incorporated by reference for all purposes: U.S. patent application Ser. No. 18/138,302, filed on Apr. 24, 2023, U.S. patent application Ser. No. 18/200,457, filed on May 22, 2023, and U.S. patent application Ser. No. 18/531,507, filed Dec. 6, 2023.

Light from the first laser (in the first optical module 302-1) is transmitted into a first field of view (FOV) 304-1 by reflecting on the first mirror 116-1 as the rotor 204 oscillates back and forth. Light from the second laser (in the second optical module 302-2) is transmitted into a second FOV 304-2 by reflecting on the second mirror 116-2 as the rotor 204 oscillates back and forth. The resulting scan range (e.g., FOV 304-1 plus FOV 304-2) can be larger than achievable by a single-sided mirror.

The multisource lidar system 300 comprises a first routing mirror 308-1 and a second routing mirror 308-2. Light from the first optical module 302-1 is reflected by the first routing mirror 308-1 toward the first mirror 116-1. Light from the second optical module 302-2 is reflected by the second routing mirror 308-2 toward the second mirror 116-2.

The routing mirror 308 can be used to fold a light path to make the system more compact and/or fit in a desired form factor. In some embodiments, the routing mirror 308 is adjusted to correct for errors in scan positions (e.g., as described in the '273 application). Thus, in some configurations, the routing mirror 308 rotates, pivots, tilts, or oscillates a few degrees for correction (e.g., the routing mirror rotation is equal to or greater than 1, 2, or 3 degrees and/or equal to or less than 5, 8, or 10 degrees).

The routing mirror 308 can be used (e.g., rotate, pivot, tilt, or oscillate) to increase the FOV 304. Field of view can be equal to twice the rotation of a mirror. Thus, by rotating a mirror by 10 degrees creates a 20-degree fOV. The routing mirror 308, in some configurations, is arranged to move (e.g., pivot about an axis that is parallel with an axis of rotation of the rotor 204) to increase the FOV 304. The routing mirror 308 can rotate, pivot, tilt, or oscillate equal to or greater than 3, 5, or 10 degrees and/or equal to or less than 10, 15, or 20, in some configurations. For example, the routing mirror 308 rotates+/−5 degrees (10 degrees total) providing a 20-degree field of view. The rotor 204 rotes the mirror 116+/−10 degrees (20 degrees total) providing a 40-degree field of view. The 20-degree field of view of the routing mirror 308 combined with the 40-degree field of view of the mirror 116 provides an 80-degree wide FOV 304.

One design constraint of having two moving mirrors in series (e.g., the routing mirror 308 and then mirror 116) is that if the first moving mirror has a large motion, then then the second mirror in the series is to be designed large enough to capture light from the first mirror, while the second mirror rotates. Thus, it can be desirable for the first mirror to have small motion (e.g., so the second mirror isn't too large). In some embodiments, the mirror 116 is wider than the routing mirror 308, and/or the mirror 116 moves (e.g., rotates by rotor 204) through a greater angular extent than the routing mirror 308. In some configurations, rotation of the mirror 116 is equal to or greater than 1, 1.25, or 1.5 the rotation of the routing mirror 308 and/or equal to or less than 1.5, 2, 3, 5, 8, 10, 20, or 40 times the rotation of the routing mirror 308. For example, routing mirror 308 rotates 1 or 2 degrees to correct for certain errors, and the mirror 116 rotates 20, 30, or 40 degrees. In another example, the routing mirror 308 rotates 10 degrees, and the mirror 116 rotates 20 degrees.

In some configurations, FOV 304-1 and FOV 304-2 are arranged to overlap in a middle region 312, giving the middle region 312 an effectively higher resolution region of interest (ROI). For example, the first FOV 304-1 is 80 degrees wide, the second FOV 304-2 is 80 degrees wide, and the second FOV 304-2 overlaps the first FOV 304-1 by 40 degrees.

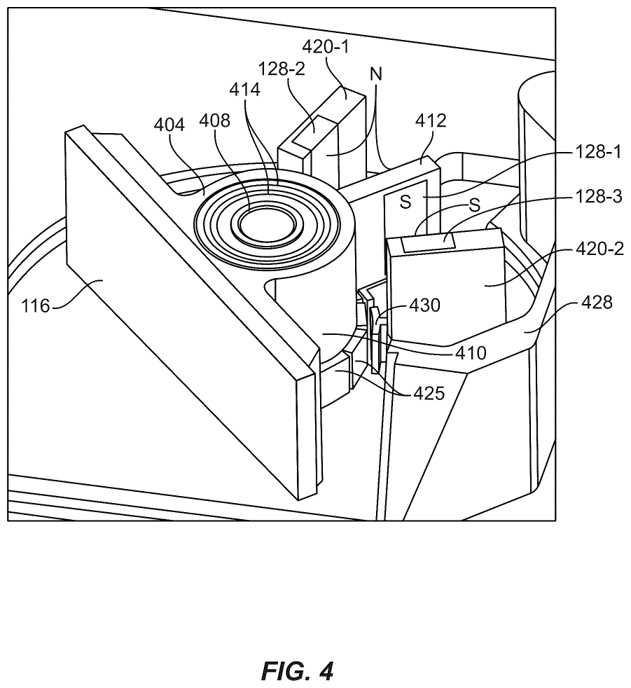

FIG. 4 illustrates a perspective view of an embodiment of an oscillating lidar mirror. A mirror 116 coupled (e.g., fixedly coupled) with a rotor 404 oscillates back and forth to direct light from a laser into a field of view of a lidar system. In FIG. 4, a single moving magnet, a first magnet 128-1, is placed on an opposite side of a pivot 408 (e.g., similar to pivot 108 in FIG. 1) from the mirror 116. The rotor 404 comprises a rotor body 410 (e.g., a portion of the rotor 404 surrounding the pivot 408) and a leg 412 (e.g., an elongate member) extending from the rotor body 410. In the embodiment shown, an elongate direction of the leg 412 is perpendicular to a plane of the mirror 116. In FIG. 4, there are two cylindrical bearings 414 between the pivot 408 and the body 410 of the rotor 404.

The first magnet 128-1 is coupled (e.g., fixedly coupled) with the leg 412 of the rotor 404. A second magnet 128-2 is coupled with a first bumper 420-1, and a third magnet 128-3 is coupled to a second bumper 420-2. Bumpers 420 are pillars, posts, walls, or other features to which magnets are mounted to stop rotation of the rotor 404 by stopping rotation of the leg 412 of the rotor 404. The second magnet 128-2 is arranged to limit angular rotation of the rotor 404 in a counterclockwise direction. The second bumper 420-2 and the third magnet 128-3 are arranged to limit an angular rotation of the rotor 404 in a direction opposite the first bumper 420-1 and second magnet 128-2 (e.g., the third magnet 128-3 limits clockwise angular rotation of the rotor 404). The bumpers 420 are part of base 428.

In some embodiments, the rotor 404 is made of aluminum, steel, titanium, or other strong, rigid material, depending on the specific application and expected forces acting on the rotor 404.

A drive motor may be a rotating motor where the rotational motion is rapidly alternated, typically by reversing the polarity of the driving voltage. In some embodiments, the drive motor may be a custom-designed motor such as depicted in FIG. 4, where the magnets 425 of the motor (e.g., motor armature) do not extend all the way around the rotor 404 (e.g., to take advantage of the fact that the motor spins less than 360, 180, 120, 100, or 90 degrees). A motor stator 430 is also shown.

In some embodiments, voice coils are embedded into magnets 128 (e.g., on the leg 412 and/or on the bumpers 420) to add an active electromagnetic field on top of a static permanent magnetic field.

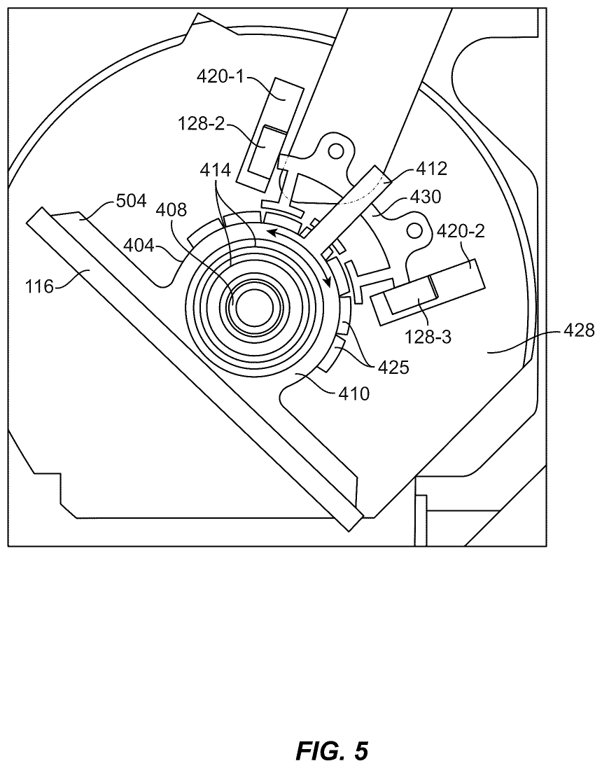

FIG. 5 depicts a top-down view of the oscillating lidar mirror in FIG. 4. FIG. 5 shows an embodiment of a system comprising a rotor 404 arranged to rotate about a pivot (e.g., pivot 408) using one or more bearings (e.g., cylindrical bearings 414). The rotor 404 comprises a rotor body 410 encircling the pivot. A mirror support 504 extends from the rotor body 410. A leg 412 extends from the rotor body 410. A mirror 116 is coupled with the rotor 404 at the mirror support 504. The mirror 116 is arranged to reflect light emitted from a laser. A motor (e.g., magnets 425 (motor armature) and stator 430) is arranged to apply a force to the rotor 404. A first magnet (e.g., first magnet 128-1 in FIG. 4) is coupled with the leg 412 of the rotor 404. The system comprises a first bumper 420-1 and a second bumper 420-2. A second magnet (e.g., second magnet 128-2) is coupled with the first bumper 420-1 and arranged to limit an angular rotation of the rotor 404 by a pole of the second magnet facing a similar pole of the first magnet.

The leg 412 extends in a direction from the rotor body 410 that is perpendicular to a plane of the mirror 116. The rotor body 410 encircles the pivot (e.g., the rotor body 410 encircles pivot 408).

In FIG. 4 and FIG. 5, there is a single moving magnet (the first magnet 128-1), arranged on the opposite side of the pivot 408 bearing from the mirror 116. The single moving magnet is on the leg 412 (as shown in FIG. 4). Each side of the moving magnet interacts with a separate bumper magnet (e.g., the second magnet 128-2 and the third magnet 128-3). In operation, the stator 430 moves the rotor 404 between +25 and −25 degrees. Magnetic bumpers (e.g., magnet 128 on bumpers 420 in FIG. 5, or the second magnet 128-2 and the fourth magnet 128-4 in FIG. 1) provide opposing magnetic fields to the moving magnet so that rotational momentum is transitioned into magnetic force. This can conserve energy the motor uses to reverse the rotor 404.

In some configurations, the system further comprises an encoder (e.g., an angle encoder) arranged to measure an angle of rotation of the rotor 404.

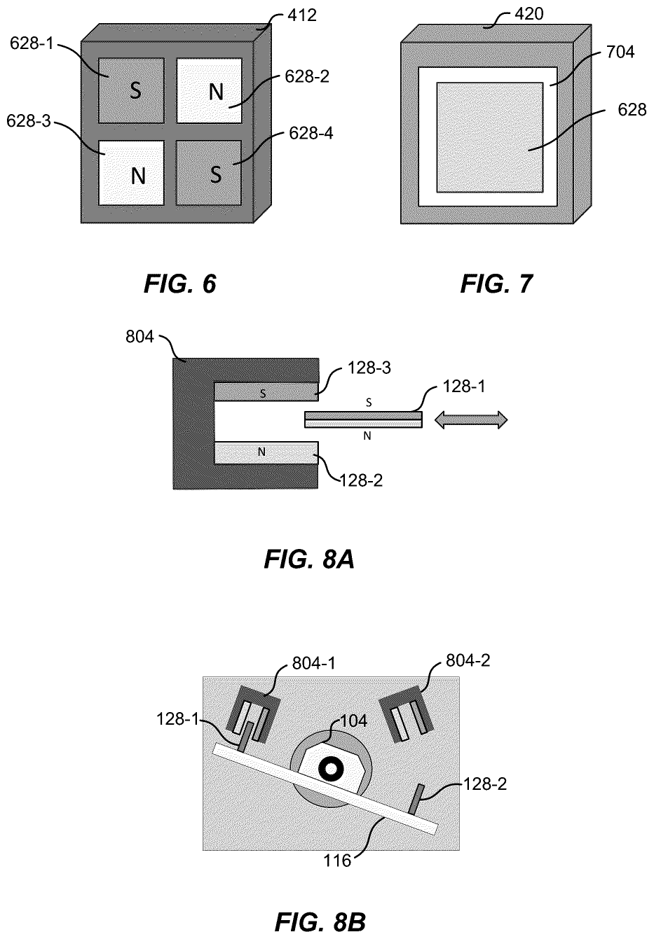

In some embodiments, it can be desirable for the mirror to have a constant angular velocity over most of the travel range so that the laser also has a constant scan speed. For this to happen, the distance over which the moving magnet(s) interact with the bumper magnet(s) can be reduced or minimized by designing the magnetic field to be contained within a limited region of space. FIGS. 6-8 show three techniques for achieving this.

FIG. 6 depicts an embodiment of using multiple magnets for a bumper magnet and multiple magnets for the moving magnet. In FIG. 6, several small magnets, with alternating poles, are used in place of a single larger magnet. The moving magnet and the bumper magnet would use matching (mirrored) designs. Far from the magnet array, the magnetic field is mostly cancelled by the alternating poles.

FIG. 6 depicts multiple magnets 628 (e.g., coupled with leg 412 from FIG. 5). The magnets 628 are arranged to take the place of magnet 128 in FIG. 1 or FIG. 4. In some embodiments, magnets 628 are similar to magnets 128, except perhaps being smaller in size. In FIG. 6, a first magnet 628-1, a second magnet 628-2, a third magnet 628-3, and a fourth magnet 628-4 are shown. Though four magnets 628 are shown, more or less than four can be used (e.g., 2, 3, 5, 6, 8, etc.). In FIG. 6, the first magnet 628-1 and the third magnet 628-3 are shown with a south pole facing outward, and the second magnet 628-2 and the fourth magnet 628-4 are shown with the north pole facing outward. Accordingly, the leg 412 has multiple magnets 628 arranged with alternating polarity.

In some embodiments, the first magnet (e.g., first magnet 628-1) is part of a first plurality of magnets coupled with the rotor. The second magnet (e.g., on bumper 420) is part of a second plurality of magnets (e.g., a mirror image of magnets 628 in FIG. 6) coupled with the bumper. The first plurality of magnets are arranged on the rotor to have alternating polarities (e.g., as shown in FIG. 6). The second plurality of magnets are arranged on the bumper to have alternating polarities, and the second plurality of magnets are arranged to limit the angular rotation of the rotor by poles of the second plurality of magnets facing similar poles of the first plurality of magnets.

Alternating poles of magnets 628 constrains the magnetic field and slows down the rotor only as the moving magnets get close to the bumper magnets. Constraining the magnetic fields can allow the rotor to rotate in a linear fashion (e.g., constant angular velocity) over a greater rotation angle compared to using unconstrained magnetic fields (e.g., single magnets without shielding). In some configurations, unconstrained magnetic fields can create errors in an angle encoder that uses magnets for measuring angles.

FIG. 7 depicts an embodiment of using a shield 704 (e.g., metal) around a magnet 628. The magnet is coupled with a bumper 420. FIG. 7 shows the shield 704 (e.g., made of iron) placed around the magnet 628 to help constrain, or limit, the extent of the magnetic field of the magnet 628.

FIG. 8A depicts an embodiment of a slot arrangement for magnets. In FIG. 8, a first magnet 128-1, a second magnet 128-2, and a third magnet 128-3 are shown. In FIG. 8, two opposing magnets (e.g., the second magnet 128-2 and the third magnet 128-3, referred to as bumper magnets) are arranged so that there is a slot between the bumper magnets. The bumper magnets are part of an embodiment of a bumper 804. The moving magnet (e.g., the first magnet 128-1) is arranged so that the moving magnet is repelled from the bumper magnets in the bumper 804 as the moving magnet is forced into the slot. The moving magnets and bumper magnets can also be reversed. The bumper magnets face each other across a gap into which the moving magnet is inserted, which can reduce a magnetic field outside the bumper 804.

FIG. 8B depicts an embodiment of an oscillating mirror using bumpers 804 from FIG. 8A. A mirror 116 is coupled with a rotor 104. A first magnet 128-1 and a second magnet 128-2 are coupled with the rotor (e.g., on an opposite side the mirror 116 as shown in FIG. 8B, or arranged perpendicular to the leg 412 in FIG. 4 to create a “t” with the leg 412).

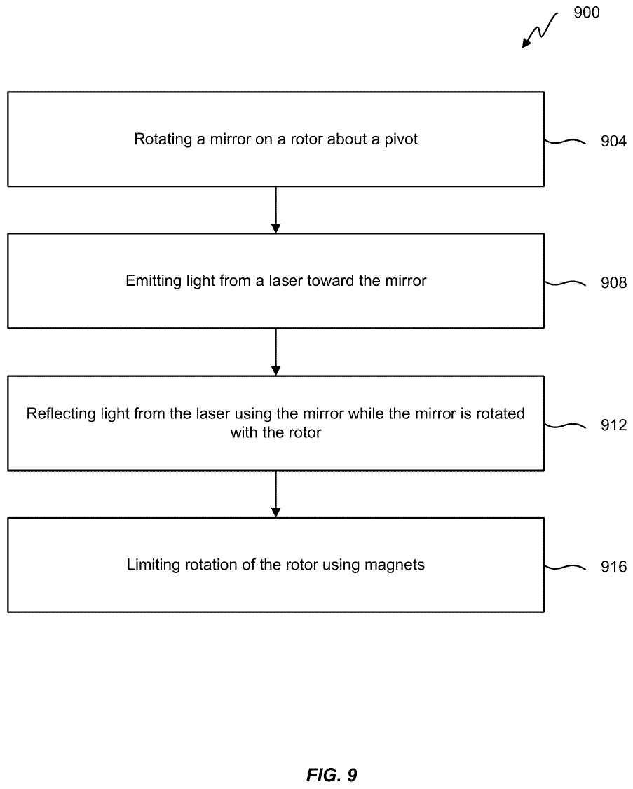

FIG. 9 illustrates a flowchart of an embodiment of a process 900 for using an oscillating mirror in a lidar system. Process 900 begins in step 904 with rotating a rotor about a pivot using one or more bearings. A mirror is coupled with the rotor. For example, mirror 116 is coupled with rotor 204 in FIG. 2, and mirror 116 is coupled with rotor 404 in FIG. 4.

In step 908, light is emitted from a laser toward the mirror. For example, light from laser 120 is emitted toward mirror 116 in FIG. 2.

In step 912, light from the laser is reflected, using the mirror, while the mirror is rotated with the rotor. For example, light reflected by mirror 116 in FIG. 3 is directed into a field of view 304 as the rotor 204 rotates the mirror 116.

In step 916, rotation of the rotor is limited using a first magnet and a second magnet. The first magnet is coupled with the rotor, and the second magnet is coupled with a base. The second magnet is arranged to limit an angular rotation of the rotor by a pole of the second magnet facing a similar pole of the first magnet. For example, the second magnet 128-2 stops rotation of the rotor by facing the first magnet 128-1 in FIGS. 1, 2, and 4.

Various features described herein, e.g., methods, apparatus, computer-readable media and the like, can be realized using a combination of dedicated components, programmable processors, and/or other programmable devices. Some processes described herein can be implemented on the same processor or different processors. Where some components are described as being configured to perform certain operations, such configuration can be accomplished, e.g., by designing electronic circuits to perform the operation, by programming programmable electronic circuits (such as microprocessors) to perform the operation, or a combination thereof. Further, while the embodiments described above may make reference to specific hardware and software components, those skilled in the art will appreciate that different combinations of hardware and/or software components may also be used and that particular operations described as being implemented in hardware might be implemented in software or vice versa.

Details are given in the above description to provide an understanding of the embodiments. However, it is understood that the embodiments may be practiced without some of the specific details. In some instances, well-known circuits, processes, algorithms, structures, and techniques are not shown in the figures.

While the principles of the disclosure have been described above in connection with specific apparatus and methods, it is to be understood that this description is made only by way of example and not as limitation on the scope of the disclosure. Embodiments were chosen and described in order to explain principles and practical applications to enable others skilled in the art to utilize the invention in various embodiments and with various modifications, as are suited to a particular use contemplated. It will be appreciated that the description is intended to cover modifications and equivalents.

Also, it is noted that the embodiments may be described as a process which is depicted as a flowchart, a flow diagram, a data flow diagram, a structure diagram, or a block diagram.

Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary. Patents, patent applications, publications, and descriptions mentioned here are incorporated by reference in their entirety for all purposes. None is admitted to be prior art.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to explain the principles of the invention and its practical applications to thereby enable others skilled in the art to utilize the invention in various embodiments and with various modifications as are suited to the particular use contemplated.

What is claimed is:

1. A system for lidar comprising:
a rotor arranged to rotate about a pivot using one or more bearings, the rotor comprising:
a body encircling the pivot;
a mirror support extending from the body; and
a leg extending from the body;
a mirror coupled with the rotor at the mirror support and arranged to reflect light emitted from a laser;
a motor arranged to apply a force to the rotor;
a first magnet coupled with the leg of the rotor;
a base; and
a second magnet coupled with the base and arranged to limit an angular rotation of the rotor by a pole of the second magnet facing a similar pole of the first magnet.

2. The system of claim 1, wherein the leg extends in a direction from the body of the rotor that is perpendicular to the mirror.

3. A system for lidar comprising:
a rotor arranged to rotate about a pivot using one or more bearings;
a mirror coupled with the rotor and arranged to reflect light emitted from a laser;
a motor arranged to apply a force to the rotor;
a first magnet coupled with the rotor;
a base; and
a second magnet coupled with the base and arranged to limit an angular rotation of the rotor by a pole of the second magnet facing a similar pole of the first magnet.

4. The system of claim 3, wherein:
the system comprises the laser;
the laser is a first laser;
the system comprises a second laser;
the mirror is a first mirror;
the system comprises a second mirror coupled with the rotor;
the first laser is arranged to illuminate the first mirror; and
the second laser is arranged to illuminate the second mirror.

5. The system of claim 3, wherein the rotor comprises a body encircling the pivot.

6. The system of claim 5, wherein:
the rotor further comprises a leg extending from the body; and
the first magnet is coupled with the leg of the rotor.

7. The system of claim 3, wherein:
the base comprises a first bumper;
the second magnet is coupled with the first bumper;
the base further comprises a second bumper; and
a third magnet is coupled with the second bumper, the third magnet arranged to limit angular rotation of the rotor in a direction opposite that the first bumper limits rotation.

8. The system of claim 3, wherein:
the first magnet is part of a first plurality of magnets coupled with the rotor;
the second magnet is part of a second plurality of magnets coupled with the base;
the first plurality of magnets are arranged on the rotor to have alternating polarities;
the second plurality of magnets are arranged on the base to have alternating polarities; and
the first plurality of magnets are arranged to limit the angular rotation of the rotor by poles of the second plurality of magnets facing similar poles of the first plurality of magnets.

9. The system of claim 3, further comprising an angle encoder arranged to measure an angle of rotation of the rotor.

10. The system of claim 3, wherein the mirror has a width equal to or greater than 1 cm.

11. The system of claim 3, wherein the first magnet and the second magnet are rare-earth magnets.

12. The system of claim 3, wherein the first magnet is mounted parallel to the mirror.

13. The system of claim 3, further comprising:
a routing mirror; and
a memory device comprising instructions that, when executed by one or more processors, adjust the routing mirror to correct for errors in scan positions.

14. A method for using an oscillating mirror comprising:
rotating a rotor about a pivot using one or more bearings, wherein a mirror is coupled with the rotor;
emitting light from a laser toward the mirror;
reflecting light from the laser using the mirror while the mirror is rotated with the rotor; and
limiting rotation of the rotor using a first magnet and a second magnet, the first magnet coupled with the rotor and the second magnet coupled with a base, the second magnet arranged to limit an angular rotation of the rotor by a pole of the second magnet facing a similar pole of the first magnet.

15. The method of claim 14, wherein:
the laser is a first laser;
the mirror is a first mirror;
the method further comprises:
emitting light from a second laser toward a second mirror concurrently with emitting light from the first laser toward the first mirror; and
reflecting light from the second laser using the second mirror while the second mirror is rotated with the rotor; and
the second mirror is coupled with the rotor.

16. The method of claim 14, wherein;
the rotor comprises a body encircling the pivot;
the rotor comprises a leg extending from the body;
the first magnet is coupled with the leg of the rotor; and
the method further comprises limiting rotation of the rotor by limiting travel of the leg of the rotor.

17. The method of claim 14, wherein:
the base comprises a first bumper;
the second magnet is coupled with the first bumper;
the base further comprises a second bumper; and
the method further comprises limiting an angular rotation of the rotor in a direction opposite that the first bumper limits rotation using a third magnet coupled with the second bumper.

18. The method of claim 14, wherein:
the first magnet is part of a first plurality of magnets coupled with the rotor;
the second magnet is part of a second plurality of magnets coupled with the base;
the first plurality of magnets are arranged on the rotor to have alternating polarities;
the second plurality of magnets are arranged on the base to have alternating polarities; and
the first plurality of magnets are arranged to limit the angular rotation of the rotor by poles of the second plurality of magnets facing similar poles of the first plurality of magnets.

19. The method of claim 14, further comprising measuring an angle of rotation of the rotor using an angle encoder.

20. The method of claim 14, wherein the mirror has a width equal to or greater than 1 cm.
